(19) United States
(12) Patent Application Publication
(10) Pub. No.: US 2018/0227266 A1
(43) Pub. Date: Aug. 9, 2018

(54) METHOD AND APPARATUS TO ENABLE DISCOVERY OF IDENTICAL OR SIMILAR DEVICES ASSEMBLED IN A SERIAL CHAIN AND ASSIGN UNIQUE ADDRESSES TO EACH

(71) Applicant: lntel Corporation, Santa Clara, CA (US)

(72) Inventors: Kevan A. Lillie, Chandler, AZ (US); Kent C. Lusted, Aloha, OR (US); Samuel A. Johnson, Portland, OR (US)

(73) Assignee: lntel Corporation, Santa Clara, CA (US)

(21) Appl. No.: 15/749,221

(22) PCT Filed: Aug. 5, 2016
(86) PCT No.: PCT/US2016/045773

§ 371 Date: Jan. 31, 2018

Related U.S. Application Data
(60) Provisional application No. 62/202,096, filed on Aug. 6, 2015.

(51) Int. Cl. H04L 29/12; H04L 12/935; H04L 12/24

(52) U.S. Cl. CPC H04L 61/2038; H04L 61/6022; H04L 45/02; H04L 41/12; H04L 41/08; H04L 49/3054

(57) ABSTRACT

Methods and apparatus for enabling discovery of and assigning unique addresses for identical or similar devices assembled in a serial chain of devices in a high-speed communications link. The method and apparatus enable an endpoint device in a communication link including a plurality of serially-connected signal buffering devices to discover each signal buffering devices, assign a unique address, and configure each signal buffering device from a central non-volatile memory (NVM) using an in-band configuration protocol for the communication link.

### CROSS-REFERENCE TO RELATED APPLICATION

This patent application is a U.S. National Phase Application under 35 U.S.C. Section 371 of International Application No. PCT/US2016/045773, filed on Aug. 5, 2016, entitled “METHOD AND APPARATUS TO ENABLE DISCOVERY OF IDENTICAL OR SIMILAR DEVICES ASSEMBLED IN A SERIAL CHAIN AND ASSIGN UNIQUE ADDRESSES TO EACH” which claims benefit of provisional 62/202,096, filed on Aug. 6, 2015, which is hereby incorporated herein by reference in its entirety and for all purposes.

### BACKGROUND INFORMATION

In serial input/output communications, a single or multiple re-driver or re-timer device(s) are often used to extend the reach of the communication link. As serial bit data rates increase the signal integrity requirements lead to more complex buffering (re-driver and re-timer) devices, which in turn require increased levels of configuration.

One problem is that the configuration of the buffering devices often requires individual non-volatile memory (NVM) devices for each buffer. These NVM devices contain the configuration information for each of the re-timer or re-driver devices (which typically include default values) and in cases where there are multiple serially-connected devices they will have different configurations. This is an issue for Ethernet applications on large system boards.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a combination schematic block and message flow diagram illustrating an overview of one embodiment to discover intermediate buffer devices in a serial chain and configure each intermediate buffer device with a unique addresses;

FIGS. 2a and 2b collectively show a message flow sequence for discovering and assigning addresses to intermediate devices in a communications link that traverses a serial chain of devices, according to one embodiment;

FIG. 3 is a block schematic architecture diagram for an endpoint device, according to one embodiment; and

FIG. 4 is a block schematic architecture diagram for an intermediate device, according to one embodiment;

FIG. 5 is a schematic diagram illustrating a communication link between a pair of endpoint devices using a serial chain of signal buffering devices connected via wired or optical cables;

FIG. 6 is a schematic diagram of a communication link between a pair of endpoint devices mounted on a printed circuit board (PCB) including a serial chain of signal buffering devices mounted on the PCB;

FIG. 7a is a schematic diagram of a multi-lane communication link between a pair of endpoint devices mounted on a PCB, wherein each lane included a serial chain of signal buffering devices mounted on the PCB;

FIG. 7b is a schematic diagram of a multi-lane communication link between a pair of endpoint devices mounted on a PCB, wherein each signal buffering device supports communication over multiple lanes; and

FIG. 7c is a schematic diagram of a multi-lane communication link between a pair of endpoint devices and signal buffering device connected to form a serial chain of devices using multiple wired or optical cables.

### DETAILED DESCRIPTION

Embodiments of methods and apparatus for enabling discovery of identical or similar devices assembled in a serial chain and assign unique addresses to each are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

High-speed links, such as 25 Gigabit per second (Gb/s) and 100 Gb/s Ethernet links, have very precise signaling requirements that limit the length of a given link (e.g., due to degradation of signals as they are transmitted over the link. To extend the length of the link, intermediate devices comprising re-driver and/or re-timer devices are inserted, thus forming multiple linked segments. In a serial chain of such devices the devices at each end (called the “endpoints” or “endpoints devices”) of the serial chain will communicate with each other to establish a link. During this link establishment phase, each intermediate device will forward the received signal and information to the next device in the chain.

Typically, an intermediate device will have a default configuration, including a default address. This poses a problem when multiple intermediate devices of the same type are part of the serial chain of devices, since if may be necessary to adjust configuration parameters in connection with establishing a link. Thus, each intermediate device needs to be uniquely identified in order to adjust its configuration. In accordance with aspects of the embodiments disclosed herein, techniques are provided that enable an endpoint to discover any and all serially-connected signal buffering devices and provides a way to uniquely identity each one, assign an address and configure each from a central NVM over the communication link's in-band configuration protocol.

In one embodiment, the first intermediate buffering device following the originating endpoint device receives a data value called “Device Address” from the endpoint. It increments the address by a count of 1, stores this value, and then forwards this new value to the next device in the chain. The value it has recorded is its unique device address and will be used when the originating endpoint needs to send unique information to that intermediate device. A second or subsequent intermediate device will receive the forwarded Device Address value and it increments it to become its own unique address. This continues until the endpoint at the far end of the link is reached. The final value of the Device Address value is returned to the originating endpoint and as such it knows how many devices are in the chain and how to address each one.

Using a central NVM to configure multiple devices over an in-band communication protocol reduces the number of NVM devices needed to configure each device. This reduces costs and complexity of the platform. It also improves usability because only one NVM program needs to be maintained. The alternative is to provide each device its own NVM which it loads on initialization. This requires extra components and NVM program development for each device. It also means that each device needs more control logic to enable the NVM execution and IO to access the NVM.

Another approach is to use an I2C or similar bus to address each device, but unique buses or unique addresses for each must be assigned and programmed, and a central controller is needed to read the NVM and issue the I2C operations. Embodiments disclosed herein minimizes the number of devices and buses needed and centralizes the management of the interface. Moreover, in one embodiment, existing communication protocols and frame structures are leveraged using standardized “next pages” to transparently manage the overall link.

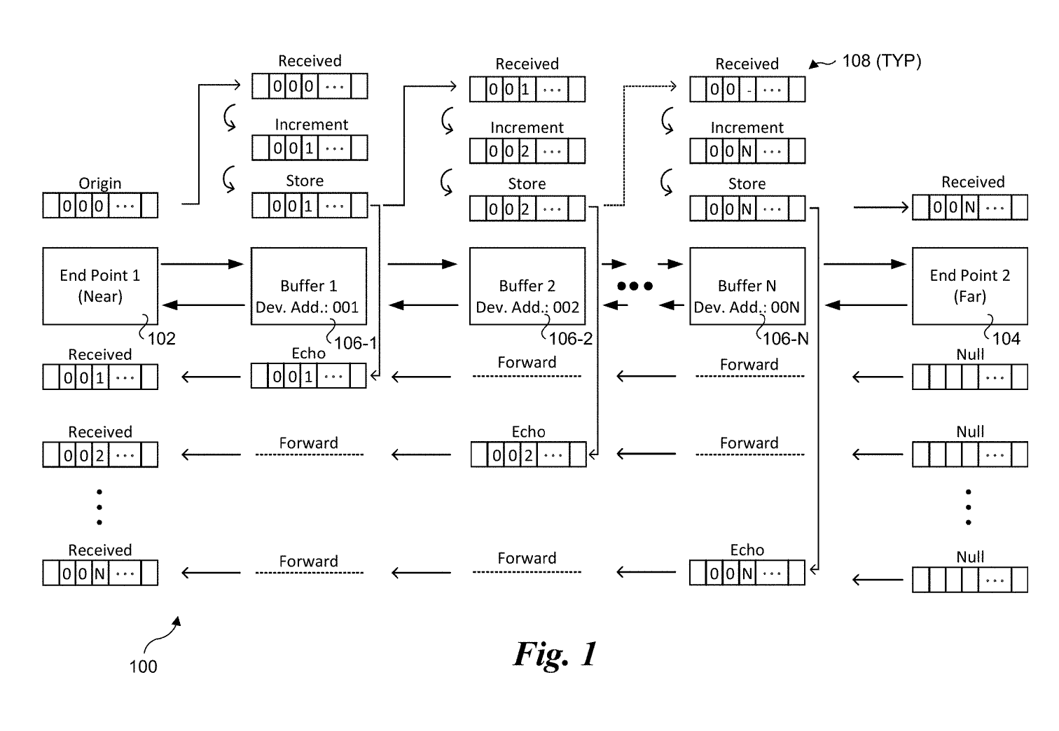

FIG. 1 is a combination schematic block and message flow diagram illustrating an overview of one embodiment to discover and assign addresses. A link chain 100 includes a near endpoint device 102 that communicates with a far endpoint device 104 via N intermediate buffer devices 106-1 . . . 106-N. For simplicity and convenience, intermediate buffer devices 106-1 . . . 106-N may also be referred to as Buffer 1 . . . Buffer N, as illustrated. FIG. 1 includes the feedback to the origin of the last address assigned and an indication of the number of devices before reaching the far-end End Point.

Each of the near and far endpoint devices 102 and 104 and intermediate buffer devices 106-1 . . . 106-N will include various circuitry and embedded logic for implementing corresponding functionality, a portion of which is configured to support link initialization operations. In one embodiment this will include a plurality of registers 108, which may comprise any type of register or otherwise any type of logic circuitry capable of storing (temporally or persistently) a value.

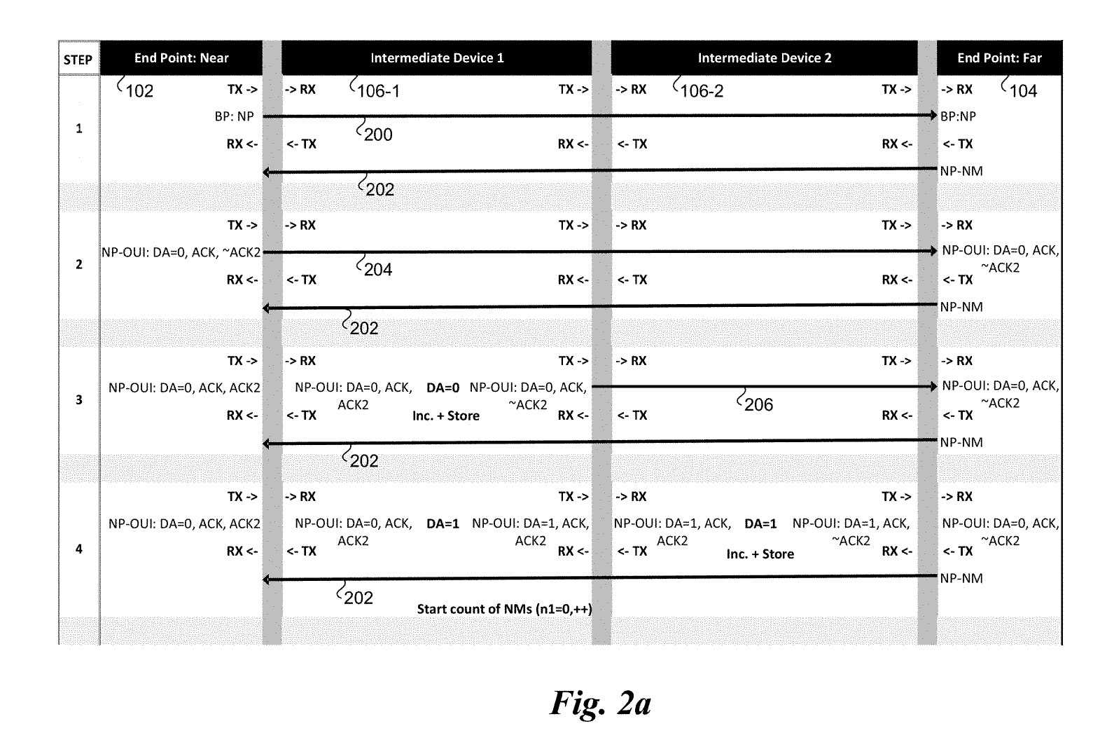

FIGS. 2a and 2b are first and second parts of a message flow diagram illustrating a sequence of messages exchanged between the various components in the linked chain 100 to initialize a link between near and far endpoint devices 102 and 104. In FIG. 2 the gray vertical bars represent the link segments between the devices, while TX-> and <-TX represents transmit ports depicting the direction of transmission and RX-> and <-RX represent receive ports showing the direction of signals being received.

The following steps (and corresponding steps shown in FIGS. 2a and 2b) are described using terms and methodology used to describe the Ethernet Auto-Negotiation procedure defined in IEEE 802.3-2012 Clause 73. However, the use of the Ethernet Auto-Negotiation procedure is merely an exemplary use case, and is not limiting, as other embodiments may use other procedures for performing auto-negotiation. Moreover, the techniques disclosed herein are not limited to Ethernet, but rather may be implemented for various types of communication links using various protocols.

The Auto-Negotiation function allows an Ethernet device to advertise modes of operation it possesses to another device at the remote end of an Ethernet link and to detect corresponding operational modes the other device may be advertising. The objective of the Auto-Negotiation function is to provide the means to exchange information between two devices that share a link and to automatically configure both devices to take maximum advantage of their abilities.

Exemplary Procedure for Discovery and Configuration of Intermediate Link Devices

Step 1. After initial link establishment and an exchange of base pages (BP) 200 with the Next Page (NP) bit set, the Device Discovery and Addressing phase can commence with its Organizationally Unique Identifier (OUI) message Next Page. When far endpoint device 104 completes its own Next Pages and is transmitting Next Pages with a Null Message (NP-NM) 202 the Device Discovery phase beings. As illustrated in FIGS. 2a and 2b, far endpoint device 104 will continuation to transmit NP-NM messages 202 to near endpoint device 102 throughout various steps during the procedure.

Step 2. An OUI Next Page 204 is transmitted from near endpoint device 102 with the Message Page bit set to logical one and with a message code field containing the OUI. The OUI identifies the message to devices that can support Device Discovery and Addressing. The Next Page bit is set to logical one. ACK (ACKnowledgement) is set to logical one to prepare all devices in the chain for the incoming messages. ACK2 is set to logical zero (The “˜” character represents not set, i.e., logical zero). The Next Page Toggle bit will function as normally defined in all messages. This initial OUI Next Page is forwarded by all intermediate devices to far endpoint device 104. A bit field in the Unformatted Code Field of the OUI message is identified to contain the Device Address (DA) value and it is initialized to zero in one embodiment. Generally, the initial DA value may be any valid address value; the use of a zero initial DA value is merely exemplary.

Step 3. After sufficient time has elapsed to ensure that all intermediate devices have recognized the OUI message, near (origin) endpoint device 102 will assert ACK2. Upon recognizing the change in logical value of ACK2, the first intermediate device will begin its DA increment and store operation. The first intermediate device continues to transmit the original OUI with ACK2 set to logical zero (as depicted by a message 206) until it has updated the Device Address (DA) in the outgoing message to far endpoint device 104.

As shown in FIG. 1, the DA increment and store operation is used to configure the address for each intermediate device. A given intermediate device receives a DA from its preceding device in the serial chain, increments the DA, and then stores the incremented value as its own DA. It then forwards its DA to the next intermediate device in the chain, and the DA increment and store operation is repeated.

Step 4. Intermediate device 1 updates the upstream message (206) to far endpoint device 104 with the incremented Device Address (DA=1) and asserts ACK2 to logical one. At this time the receive side of Intermediate Device 1 starts a counter (n1) to count the number of Null Messages (NM) received from far endpoint device 104. Upon receipt of ACK2 asserted to logical one, Intermediate Device 2 begins its increment and store operation.

Step 5. Intermediate Device 2 updates its outgoing upstream message 208 with ACK2 set to logical one once its Device Address is updated in the message (DA=2). It starts a Null Message counter (n2) on the receive side from far endpoint device 104. Far endpoint device 104 does not respond to the OUI. As each NP-NM message 202 is received by Intermediate Devices 1 and 2, their respective n1 and n2 counters are incremented.

Step 6. Intermediate Device n1 counter reaches the determined number of Null Messages on its receiver from far endpoint device 104.

Step 7. At this point, Intermediate Device 1 replaces the incoming NP-NM messages 202 with the OUI Next Page and transmits its device address with ACK2 set to logical one near endpoint device 102.

Step 8. Intermediate Device 2's Null Message counter (n2) reaches the determined count and inserts the OUI Next Page with its Device Address (DA=2). Intermediate Device 1 recognizes the change on its upstream receiver and forwards the new message to near endpoint device 102: Near endpoint device 102 then waits for sufficient time to ensure that all intermediate devices have reported their assigned addresses to the origin before discontinuing the discovery phase and transmitting Null Message Next Pages, at which point Auto Negotiation will complete since both sides are transmitting Null Messages.

Returning to FIG. 1, the foregoing procedure can be applied to N intermediate (e.g., signal buffering) devices in a similar manner. As shown, in one embodiment that starts with a base device address of 0, each device on the chain will have the same device address as its order in the serial chain, e.g., first device address=1, second device address=2, Nth device address=N. As each intermediate device (Buffer 1-N) establishes its address, that address is echoed back to its preceding device, and henceforth the remaining devices in the chain will forward the echoed device address back to the originating device (end point device 102). Upon inspection, this originating endpoint device can determine both the number of intermediate devices in the chain and the unique address for each device.

In one embodiment, device addresses are echoed back by adding the device address to AN Next Page Message sent from far endpoint device 104 to the near endpoint device 102. In one embodiment, once a given intermediate devices has stored its device address, that DA is added to each AN Next Page Message originating from far endpoint device 104 until the given intermediate device detects that a device address has already been added to an AN Next Page Message by the next device in the serial chain of devices.

As mentioned above, the use of 0 for the base address of the origin device is merely exemplary. Substantially any address could be used as a base address for the origin device. In addition, incrementing the address by 1 is also merely exemplary. Generally, each intermediate device can increment the address it receives by a predetermined amount to establish its own address. For example, the increment could be 1, 5, 10, or any predetermined integer. By knowing the increment being used, the originating device can determine the number of intermediate devices in the chain, as well as the unique address for each intermediate device.

Exemplary Endpoint Device

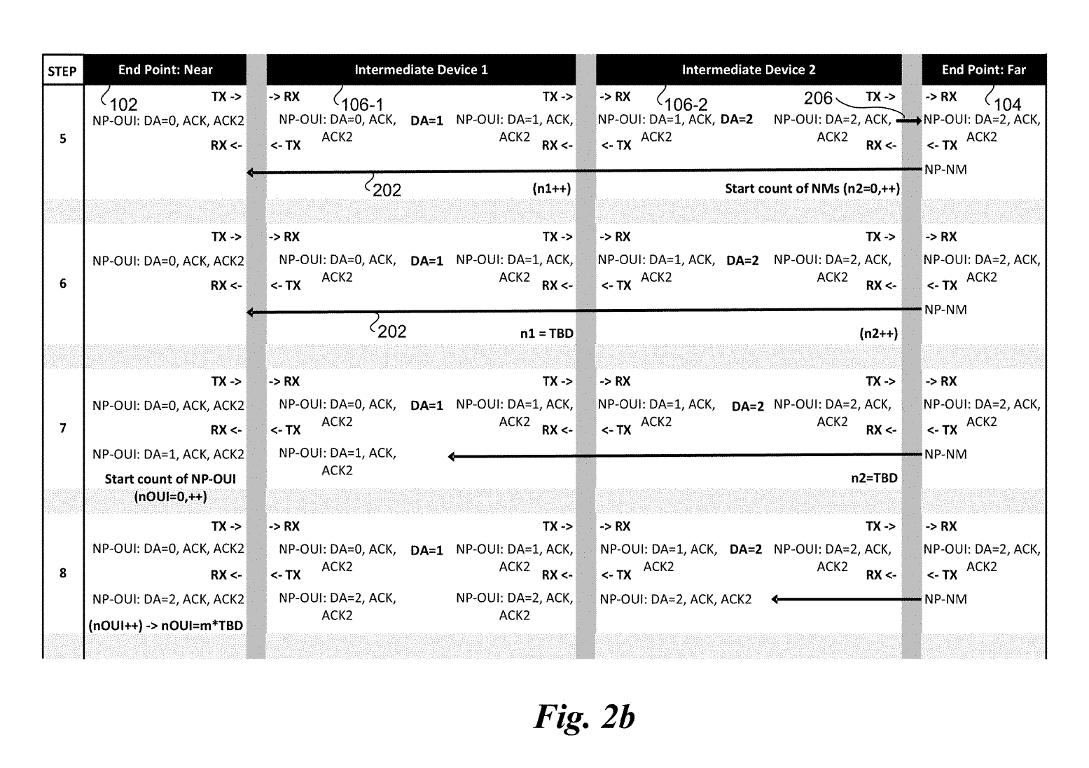

FIG. 3 shows an architecture for an endpoint device 300 employing a network chip 302 configured to perform link initialization including auto-negotiation operations in accordance with aspects of the embodiments disclosed herein. Network chip 302 comprises PHY (Physical Layer) circuitry 304 including a Physical Coding Sublayer (PCS) module 305, a Reed-Solomon Forward Error Correction (RS-FEC) module 306, a Physical Medium Attachment (PMA) module 307, a PMD module 308, an Auto-Negotiation module 309 including Buffer and/or registers 310, a network port 311 including a transmitter (Tx) 312 having transmitter circuitry 313 and a receiver (Rx) 314 having receiver circuitry 315. Depending on the PHY that is implemented, network port 311 will be configured to employ 1-4 lanes, wherein each lane includes a respective transmitter 312 and receiver 314.

Network chip 302 further includes a DMA (Direct Memory Access) interface 316, a Peripheral Component Interconnect Express (PCIe) interface 318, a MAC (Media Access Channel) module 320 and a Reconciliation Sublayer (RS) module 322. Endpoint device 300 also comprises a System on a Chip (SoC) 324 including a Central Processing Unit (CPU) 326 having one or more processor cores, coupled to a memory interface 328 and a PCIe interface 330 via an interconnect 332. Memory interface 328 is further depicted as being coupled to memory 334. Under a typical configuration, network chip 302, SoC 324 and memory 334 will be mounted on or otherwise operatively coupled to a circuit board 336 that includes wiring traces for coupling these components in communication, as depicted by single lines connecting DMA 316 to memory 334 and PCIe interface 318 to PCIe interface 330 at a PCIe port 338. As an optional configuration, the components depicted for SoC 324 and network chip 302 may be combined on an SoC, a multi-chip module, or a device having similar device packaging.

In one embodiment, MAC module 320 is configured to implement aspects of the MAC layer operations performed that are well-known in the art. Similar, RS module 322 is configured to implement reconciliation sub-layer operations.

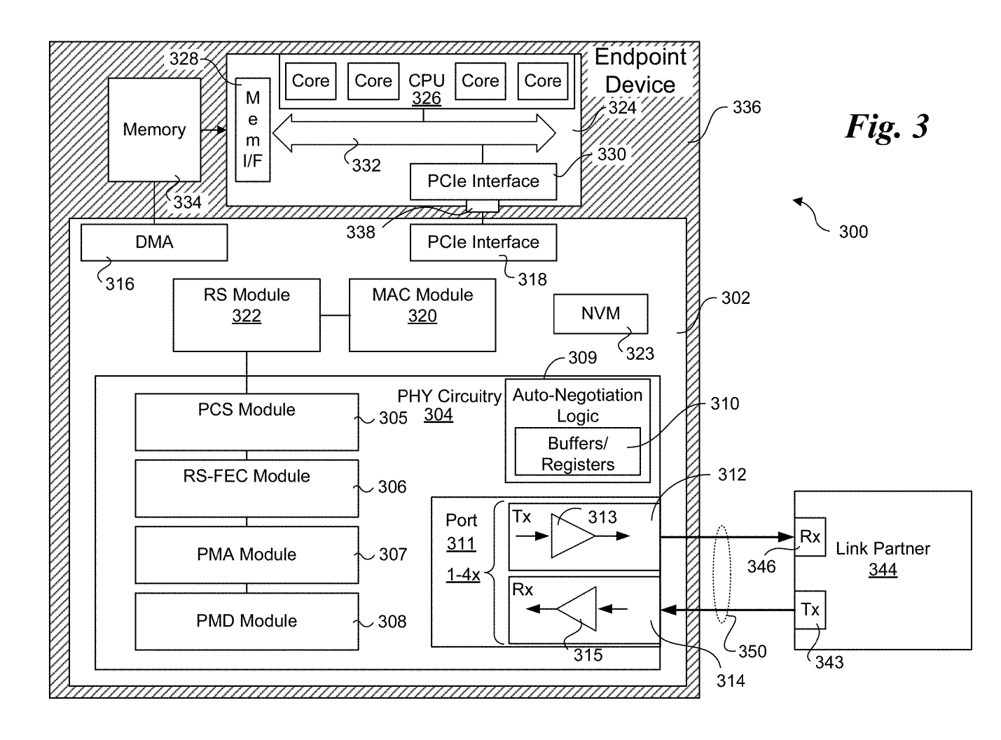

During link initialization operations, embedded logic in Auto-Negotiation module 309 is implemented to perform the auto-negotiation operations of the endpoint devices, as depicted in FIGS. 1, 2a, and 2b and discussed above. During link initialization and during subsequent data transfer operations, data is exchanged between PHY transmit and receive ports 312 and 314 of endpoint device 300 and its link partner, as depicted by a link partner 344 including a receiver port 346 and a transmitter port 348 and are linked in communication via an Ethernet link 350. In one embodiment link partner 344 comprises an intermediate device having a configuration shown in FIG. 4.

Under various embodiments, network chip 302 comprises one of a 25 Gb/s Ethernet Network Interface Controller (NIC) chip employing an IEEE 802.3 25GBASE-KR PHY or a 25GBASE-CR PHY, or a 100 Gb/s Ethernet NIC chip employs a 100GBASE-KR PHY or a 100GBASE-CR PHY. More generally, network chip 302 comprises interfaces with signaling rates such as and not limited to 25 Gb/s, 50 Gb/s or 100 Gb/s and beyond using any existing or future protocol. However, the circuitry and components of network chip 302 may also be implemented in other types of chips and components, including SoCs, multi-chip modules, and NIC chips including support for multiple network interfaces (e.g., wired and wireless). In addition, other PHYs and associated protocols may implemented in addition to Ethernet, such as but not limited to PHYs for PCIe links and InfiniB and links.

Exemplary Intermediate Device

FIG. 4 shows an architecture for an intermediate device 400 configured to implement aspects of the method operations described herein. Intermediate device 400 includes a pair of ports 400-0 and 400-1 (Port 0 and Port 1), each having PHY circuitry 304 similar to that shown in FIG. 3 and described above. As before, PHY circuitry 304 includes a Tx and Rx ports 312 and 314, each of which is coupled to an Rx port and Tx port of an upstream or downstream device (as applicable). Presuming an ordering from left to right, when implemented in a serial chain, Port 0 is connected to an upstream device, while Port 1 is connected to a downstream device.

A primary function of an intermediate (buffer) device is signal re-timing and/or re-driving. These functions are performed by re-timer/re-driver circuitry blocks 406 (one block for each direction), as shown. The particular re-timer and re-driver circuits will depend on the PHY being used for the serial chain. Generally, re-timer circuitry is configured to correct timing errors in the received signal, and may typically employ well-known circuitry for this purpose, such as phase lock loops. Re-driver circuitry may typically include one or more amplifier circuits, as well as various types of well-known signal-conditioning circuitry used to increase the drive level of a received signal. Such re-timer and re-driver circuitry is well-known to those skilled in the high-speed interconnect arts, and, accordingly, no further details are shown or discussed herein.

Exemplary Communication Link Structures

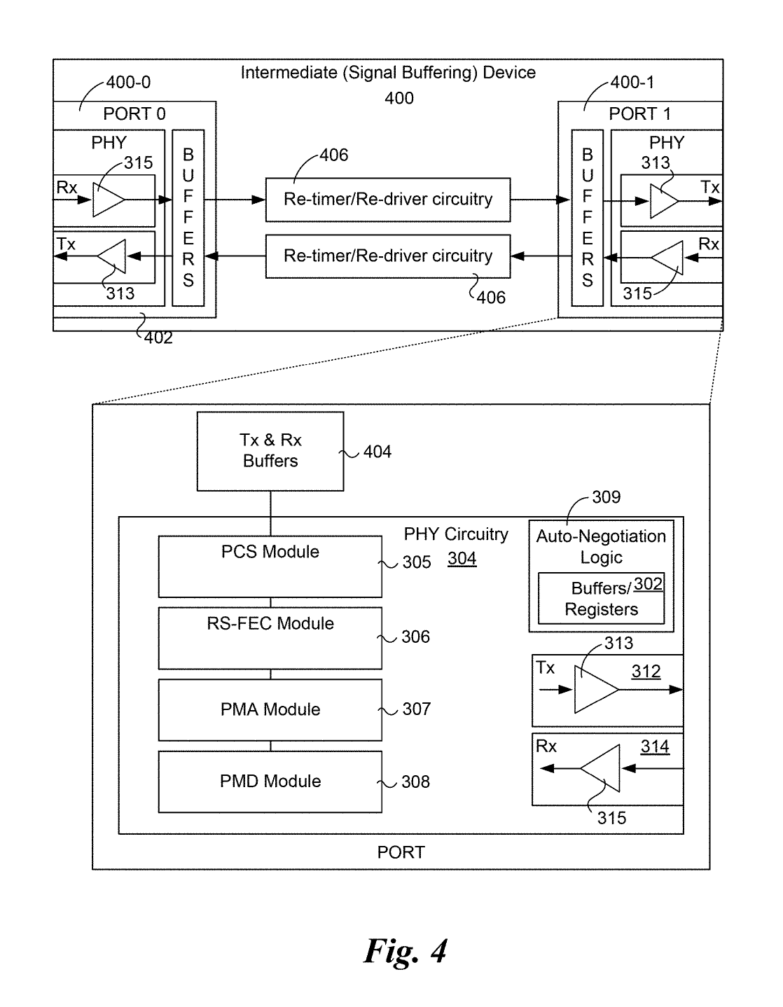

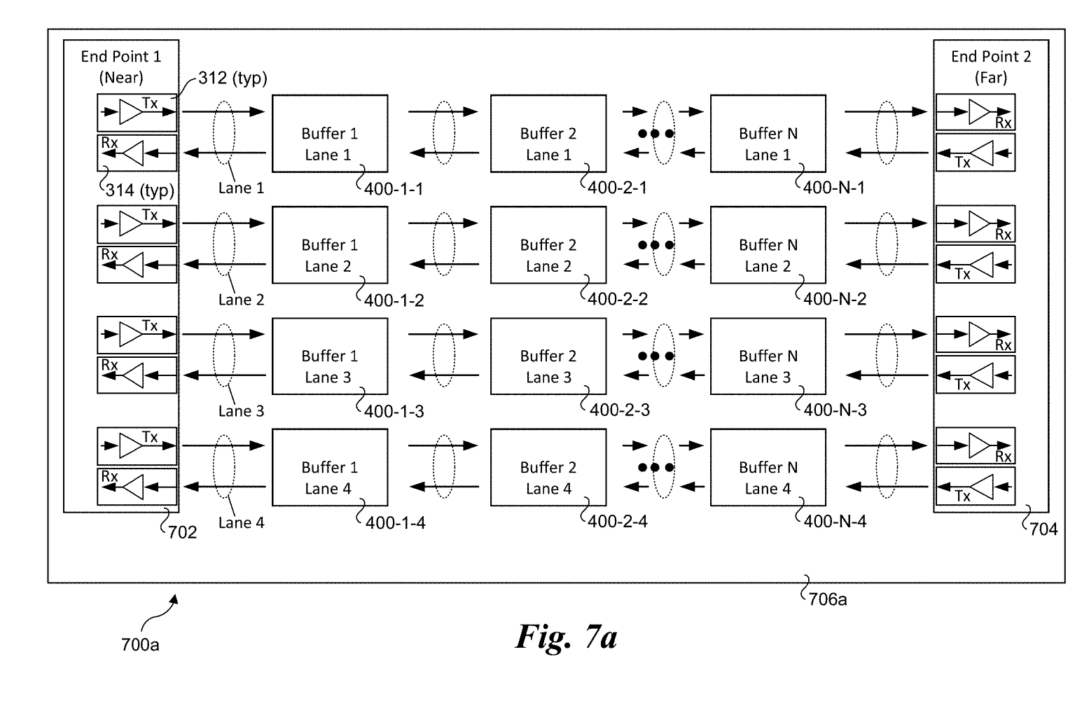

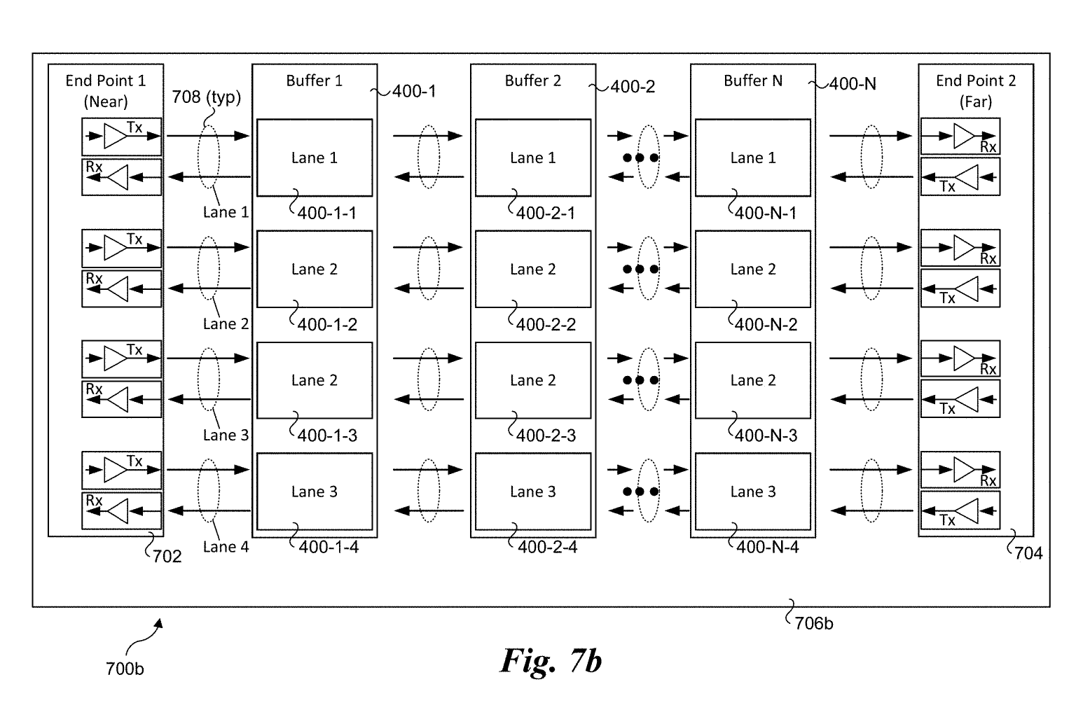

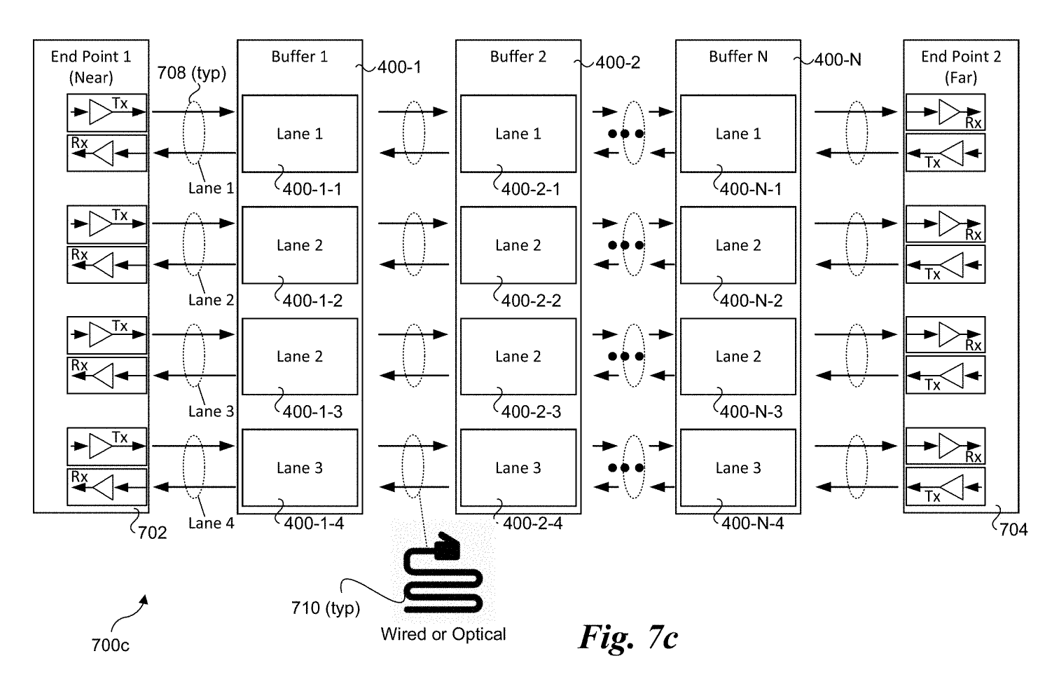

Examples of communication link structures linking a pair of endpoints in communication via a serial chain of signal buffering devices are shown in FIGS. 5-7. For example, FIG. 5 shows a communication link 500 coupling a pair of endpoint devices 502 and 504 in communication using a serial chain of signal buffering devices 400-1 . . . 400-N connected via wired or optical cables 502. Generally, a given high-speed Ethernet link will employ 1-4 lanes in each direction. For example, Ethernet links employing a 25GBASE-KR PHY or a 25GBASE-CR PHY use a single lane in each direction, while Ethernet links employing a 100GBASE-KR PHY or a 100GBASE-CR PHY use four lanes in each direction. Under alternative embodiments, as illustrated by exemplary printed circuit board (PCB) implementations in FIGS. 7a and 7b, a multi-lane link may include a respective signal buffering device for each lane, or a single signal buffering device may be configured to buffer signals for multiple lanes. For single-lane signal buffering devices, a separate cable will be connected at each end of the device. Signal buffering devices supporting multiple lanes may be connected using one or more cables between pairs of devices.

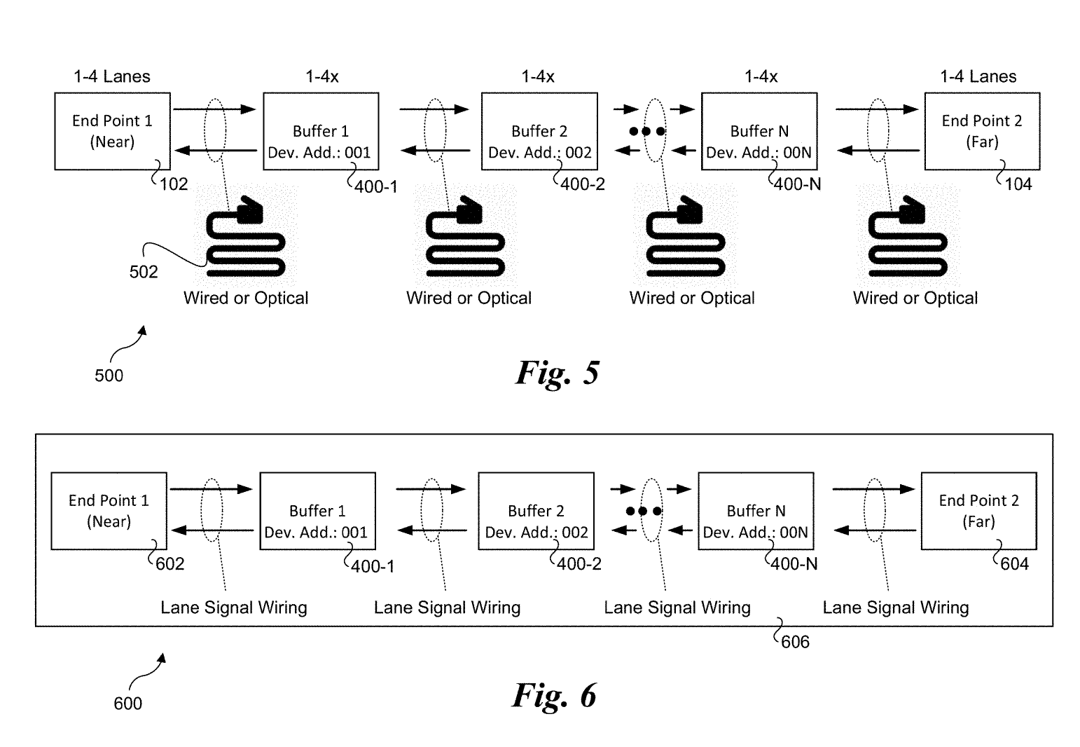

FIG. 6 shows a communication link 600 between a pair of endpoint devices 602 and 604 mounted on a printed circuit board (PCB) 602 that includes a serial chain of signal buffering devices signal buffering devices 400-1 . . . 400-N mounted on the PCB. Communication link 600 employs a single lane in each direction, and will include a corresponding set of lane signal wiring coupled between each pair of devices in the serial chain of devices.

FIG. 7a shows an embodiment of a multi-lane communication link 700a coupling a pair of endpoint devices 702 and 704 mounted on a PCB 706a in communication, wherein each of four lanes includes a respective serial chain of signal buffering devices 400 mounted on the PCB. In FIG. 7a, each of the signal buffering devices is labeled 400-i-k, where i is the buffer number and k is the lane number. As further illustrated, each of endpoint devices 702 and 704 include four pairs of transmitters 312 and receivers 314, one for each lane in each direction.

FIG. 7b shows a multi-lane communication link 700b coupling a pair of endpoint devices 702 and 704 mounted on a PCB 706b in communication, and including N signal buffering devices 400-1 . . . 400-N that are serially-connected forming a serial chain of devices. Each of the signal buffering devices 400-1 . . . 400-N supports signal buffering functionality for four lanes, wherein the signal buffering circuitry for each lane is similar to that included in the individual lane signal buffering devices of FIGS. 4-6 and 7a. In addition PCB 706b includes a respective set of wiring 708 to support communication for each direction for each of the four lanes.

FIG. 7c shows a multi-lane communication link 700c coupling a pair of endpoint devices 702 and 704 in communication via N signal buffering devices 400-1 . . . 400-N that are serially-connected forming a serial chain of devices. Under multi-lane communication link 700c, each pair of devices in the serial chain of devices is connected by four wired or optical cables 710.

Under a multi-lane implementation that employs signal buffering devices that support multiple lanes, such as shown in FIGS. 7b and 7c, discovery and configuration of the signal buffering devices 400-1 . . . 400-N is enabled through use of the techniques described above for a signal-lane link implemented using in-band signaling on one of the multiple lanes. Subsequently, link training would be implemented for each of the multiple lanes separately in accordance with the applicable link training process defined by the specification for that particular type of multi-lane communication link.

Further aspects of the subject matter described herein are set out in the following numbered clauses:

1. A computer-implemented method, comprising,
discovering each of a plurality of serially-connected signal buffering devices in a communication link between first and second endpoint devices including the plurality of serially-connected signal buffering devices, the first and second endpoint devices and the plurality of serially-connected signal buffering devices forming a serial chain of devices; and
automatically configuring each of the plurality of serially-connected signal buffering devices,
wherein at least two of the plurality of serially-connected signal buffering devices are the same type of device, and wherein each of the plurality of serially-connected signal buffering devices is configured with a unique device address.

2. The computer-implemented method of clause 1, wherein each of the plurality of serially-connected signal buffering devices is configured using a central non-volatile memory (NVM) device comprising one of the first and second endpoint devices;

3. The computer-implemented method of clause 1 or 2, wherein the at least two of the plurality of serially-connected signal buffering devices that are the same type of device comprise re-driver devices.

4. The computer-implemented method of any of the preceding clauses, wherein the at least two of the plurality of serially-connected signal buffering devices that are the same type of device comprise re-timer devices.

5. The computer-implemented method of any of the preceding clauses, wherein the at least two of the plurality of serially-connected signal buffering devices that are the same type of device comprise re-timer and re-driver devices.

6. The computer-implemented method of any of the preceding clauses, wherein the communication link employs a signaling rate of at least 25 Gigabits per second.

7. The computer-implemented method of any of the preceding clauses, wherein the communication link employs one of an IEEE 802.3 25GBASE-KR Physical Layer (PHY), a 25GBASE-CR PHY, a 100GBASE-KR PHY or a 100GBASE-CR PHY.

8. The computer-implemented method of any of the preceding clauses, wherein the link comprises an Ethernet link.

9. The computer-implemented method of clause 8, further comprising employing Ethernet Auto-Negotiation (AN) Next Pages to convey device address information between at least one of the endpoint devices and each of the plurality of serially-connected signal buffering devices.

10. The computer-implemented method of any of the preceding clauses, wherein each of the plurality of serially-connected signal buffering devices comprises one of N intermediate device in the serial chain of devices, the method further comprising:
at each of the N intermediate devices;
   if the device is first intermediate device in the serial chain of devices,
      receiving a base address from the first endpoint device; and
      incrementing the base address by a predetermined amount to produce an incremented device address;
      otherwise, if the intermediate device is not the first intermediate device in the serial chain of devices,
      receiving a previous device address from a previous device in the serial chain of devices; and
      incrementing the previous device address by a predetermined amount to produce an incremented device address;
      storing the incremented device address on the intermediate device, the stored incremented device address comprising that intermediate device's unique device address; and
      if the intermediate device is not the Nth intermediate device,
         forwarding its incremented device address to be received as a previous device address by a next intermediate device in the serial chain of devices.

11. The computer-implemented method of clause 10, wherein the communication link comprises an Ethernet link, further comprising:
exchanging Ethernet Auto-Negotiation (AN) Next Pages between the first and second endpoint device;
for each intermediate device in the serial chain of devices,
forwarding AN Next Pages that it receives originating from the second endpoint device to a previous device in the serial chain of devices;
forwarding AN Next Pages that it receives originating from the first endpoint device to a next device in the serial chain of devices; and
for at least one AN next Page that it receives originating from the first endpoint device, forwarding its incremented device address to be received as a previous device address by a next intermediate device by adding the incremented device address to the at least one AN Next Page.

12. The computer-implemented method of clause 10 or 11, further comprising:
for each intermediate device in the serial chain of devices,
communicating the unique device address for the intermediate device to the first endpoint.

13. The computer-implemented method of clause 12, further comprising:
at each intermediate device in the serial chain of devices,
echoing its unique device address to its previous intermediate device;
for each intermediate devices in the serial chain of devices prior to the intermediate device echoing its unique device address,
forwarding the unique device address it receives to a previous device in the serial chain of devices.

14. The computer-implemented method of clause 12 or 13, wherein the communication link comprises an Ethernet link, further comprising:
exchanging Ethernet Auto-Negotiation (AN) Next Pages between the first and second endpoint device;
for each intermediate device in the serial chain of devices,
forwarding AN Next Pages that it receives originating from the second endpoint device to a previous device in the serial chain of devices;
forwarding AN Next Pages that it receives originating from the first endpoint device to a next device in the serial chain of devices; and
for at least one AN next Page that it receives originating from the second endpoint device, communicating the unique device address for the intermediate device to the first endpoint by adding the unique device address to the at least one AN Next Page.

15. The computer-implemented method of clause 1, wherein discovery and configuration of each of a plurality of serially-connected signal buffering devices is performed by sending communications over the communication link using in-band signaling.

16. The computer-implemented method of clause 1, wherein discovery and configuration of each of a plurality of serially-connected signal buffering devices is performed by sending communications over the communication link using in-band signaling.

17. An apparatus, comprising:
a network port, including a transmitter and a receiver; and
circuitry and logic that is configured, when the apparatus is implemented as a first endpoint device in a communication link between the apparatus and a second endpoint device, the communication link including a plurality of serially-connected signal buffering devices comprising intermediate devices in a serial chain of devices including the apparatus and the second endpoint device, to:
   discover each of the plurality of intermediate devices; and
   for each of the plurality of intermediate devices, at least one of configure
and identify a unique device address for that intermediate device.

18. The apparatus of clause 17, wherein the circuitry and logic is further configured, when implemented as the first endpoint device, to:
transmit a message to a first intermediate device in the serial chain of devices including a base address; and
receive a device address from the first intermediate device that is generated as a function of the base address.

19. The apparatus of clause 18, wherein the apparatus further comprises non-volatile memory (NVM), and wherein the circuitry and logic is further configured, when implemented as the first endpoint device, to:
receive a respective device address from each of the plurality of intermediate devices; and
store the respective device addresses in the NVM.

20. The apparatus of any of clauses 17-19, wherein the communication link employs a signaling rate of at least 25 Gigabits per second.

21. The apparatus of any of clauses 17-20, wherein the communication link employs one of an IEEE 802.3 25GBASE-KR Physical Layer (PHY), a 25GBASE-CR PHY, a 100GBASE-KR PHY or a 100GBASE-CR PHY.

22. The apparatus of any of clauses 17-20, wherein the apparatus is an Ethernet apparatus, and the transmitter and receiver are configured to respectively transmit and receive Ethernet signals having a signaling rate of at least 25 Gigabits per second.

23. The apparatus of clause 22, wherein the circuitry and logic includes Ethernet Auto-Negotiation (AN) logic, and wherein discovery of each of the plurality of intermediate devices is facilitated by transmitting and receiving AN Next Pages over the communication link.

24. The apparatus of clause 23, wherein Ethernet Auto-Negotiation (AN) logic is configured to:
exchange AN Next Pages with the second endpoint device by transmitting AN Next pages over the communication link to the second endpoint device and receiving AN Next pages over the communication link from the second endpoint device;
inspect the AN Next Pages received from the second endpoint device to determine if they contain a device address, wherein the device address identifies the device address of an intermediate device; and storing each unique device address that is received in an AN Next Page.

25. The apparatus of any of clauses 17-24, wherein the apparatus comprises a network interface controller (NIC).

26. The apparatus of any of clauses 17-25, wherein the communication link comprises a multi-lane link, and the apparatus is configured to employ one of the lanes in the multi-lane link to discover each of the plurality of intermediate devices and at least one of configure and identify the unique device address for each of the plurality of intermediate devices.

27. An apparatus comprising a signal buffering device, including:
a first port having a first transmitter and a first receiver coupled to a first plurality of buffers;
a second port having a second transmitter and a second receiver coupled to a second plurality of buffers; and
circuitry and logic that is configured, when that apparatus is implemented as an intermediate device in a communication link including a plurality of serially-connected signal buffering devices, each comprising an intermediate device in a serial chain of devices, to:
   receive an address at the first receiver from a previous device in the serial chain of devices;
   increment the address to create an incremented address;
   store the incremented address on the apparatus to be used as a unique device address in the serial chain of devices; and
   transmit the incremented address from the second transmitter to a next device in the serial chain of devices.

28. The apparatus of clause 27, wherein the apparatus comprises an Ethernet apparatus that is configured to support Auto-Negotiation (AN) Next Pages, and wherein the circuitry and logic is further configured, when implemented as an intermediate device in the serial chain of devices, to:
receive, at the first receiver, an AN Next Page message from the previous device in the serial chain of devices;
add the incremented device address to the AN Next Page message; and
forward the AN Next Page message from the second transmitter to the next device in the serial chain of devices.

29. The apparatus of clause 27 or 28, wherein the circuitry and logic is further configured, when the apparatus is implemented as an intermediate device in the serial chain of devices, to transmit the incremented address from the first transmitter to the previous device in the serial chain of devices.

30. The apparatus of clause 29, wherein the apparatus comprises an Ethernet apparatus that is configured to support Auto-Negotiation (AN) Next Pages, and wherein the circuitry and logic is further configured, when implemented as an intermediate device in the serial chain of devices, to:
receive, at the second receiver, an AN Next Page message from the next device in the serial chain;
add the incremented device address to the AN Next Page message; and
forward the AN Next Page message from the first transmitter to the previous device in the serial chain.

31. The apparatus of any of clauses 27-30, wherein the circuitry and logic is further configured, when implemented as an intermediate device in the serial chain of devices, to:
receive, at the second receiver, a message from the next device in the serial chain including a device address; and
forward the message from the first transmitter to the previous device in the serial chain.

32. The apparatus of any of clauses 27-31, wherein the apparatus comprises a re-timing device and further comprises re-timing circuitry coupled to at least one buffer in each of the first and second plurality of buffers.

33. The apparatus of any of clauses 27-31, wherein the apparatus comprises a re-driver device and further comprises re-driver circuitry coupled to at least one buffer in each of the first and second plurality of buffers.

34. The apparatus of any of clauses 27-31, wherein the apparatus comprises a re-timing and re-driving device, further comprising:
re-timing circuitry coupled to at least one buffer in each of the first and second plurality of buffers; and
re-driver circuitry coupled to at least one buffer in each of the first and second plurality of buffers.

35. The apparatus of any of clauses 27-34, wherein each of the first and second ports comprise Ethernet ports that are configured to transmit and receive Ethernet signals having a signaling rate of at least 25 Gigabits per second.

36. The apparatus of clause 35, wherein each of the first and second ports includes circuitry and logic comprising Ethernet Auto-Negotiation (AN) logic, and wherein the apparatus is configured to transmit and receive AN Next Pages.

37. The apparatus of clause 36, wherein the communication link employs one of an IEEE 802.3 25GBASE-KR Physical Layer (PHY), a 25GBASE-CR PHY, a 100GBASE-KR PHY or a 100GBASE-CR PHY.

38. A system comprising:
first and second endpoint devices, each endpoint device including,
   a network port including a transmitter and a receiver;
a plurality of serially-connected signal buffering devices, each signal buffering device including,
   a first port having a first transmitter and a first receiver coupled to a first plurality of buffers; and
   a second port having a second transmitter and a second receiver coupled to a second plurality of buffers,
wherein the first endpoint device is connected to a first signal buffering device among the plurality of signal buffering devices, and an Nth signal buffering device among the plurality of signal buffering devices is connected to the second endpoint device to form a communication link comprising a serial chain of devices including N signal buffering devices, and
wherein the first and second endpoint devices and the plurality of signal buffering devices are configured to exchange messages to enable discovery of each of the signal buffering devices by at least one of the first and second endpoint devices and to configure each of the plurality of signal buffering devices with a unique device address in the serial chain of devices.

39. The system of clause 38, wherein each of the first and second endpoint devices and the plurality of signal buffering devices are Ethernet devices.

40. The system of clause 38 or 39, wherein each of the plurality of signal buffering devices is implemented as an intermediate device in a serial chain of devices forming a communication link coupling the first and second endpoints in communication, wherein each of the signal buffering devices is configured to:
receive an address at its first receiver from a previous device in the serial chain of devices;
increment the address to create an incremented address;
store the incremented address to be used as its unique device address in the serial chain of devices; and
transmit the incremented address from its second transmitter to a next device in the serial chain of devices.

41. The system of clause 40, wherein the first endpoint device is configured to send a base address to the first signal buffering device, the base address comprising the address received at the first receiver of the first signal buffering device.

42. The system of any of clauses 38-41, wherein each of the plurality of signal buffering devices is configured to communicate its unique device address to the first endpoint device.

43. The system of any of clauses 38-42, wherein, wherein each of the first and second endpoint devices and the plurality of signal buffering devices are Ethernet devices, wherein the first and second endpoints are configured to exchange Auto-Negotiation (AN) Pages in connection with setting up an Ethernet link that traverses the serial chain of devices, and wherein, each signal buffering device is configured to:
receive a first AN Page by from a previous device in the serial chain of devices;
add its device address to the first AN Page;
forward the first AN Page with its device address to a next device in the serial chain of devices;
receive a second AN Page from the next device in the serial chain of devices;
add its device address to the second AN Page; and
forward the second AN Page including its device address to the previous device in the serial chain of devices.

44. The system of any of clauses 38-43, wherein the communication link employs a signaling rate of at least 25 Gigabits per second.

45. The system of any of clauses 38-44, wherein the communication link employs one of an IEEE 802.3 25GBASE-KR Physical Layer (PHY), a 25GBASE-CR PHY, a 100GBASE-KR PHY or a 100GBASE-CR PHY.

46. The system of any of clauses 38-45, wherein each of the signal buffering devices comprises a re-timing device and further comprises re-timing circuitry coupled to at least one buffer in each of the first and second plurality of buffers.

47. The apparatus of any of clauses 38-45, wherein each of the signal buffering devices comprises a re-driver device and further comprises re-driver circuitry coupled to at least one buffer in each of the first and second plurality of buffers.

48. The apparatus of any of clauses 38-45, wherein each of the signal buffering devices comprises a re-timing and re-driving device, further comprising:
re-timing circuitry coupled to at least one buffer in each of the first and second plurality of buffers; and
re-driver circuitry coupled to at least one buffer in each of the first and second plurality of buffers.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

1.-30. (canceled)

31. A computer-implemented method, comprising,
discovering each of a plurality of serially-connected signal buffering devices in a communication link between first and second endpoint devices including the plurality of serially-connected signal buffering devices, the first and second endpoint devices and the plurality of serially-connected signal buffering devices forming a serial chain of devices; and
automatically configuring each of the plurality of serially-connected signal buffering devices,
wherein at least two of the plurality of serially-connected signal buffering devices are the same type of device, and wherein each of the plurality of serially-connected signal buffering devices is configured with a unique device address.

32. The computer-implemented method of claim 31, wherein each of the plurality of serially-connected signal buffering devices is configured using a central non-volatile memory (NVM) device comprising one of the first and second endpoint devices;

33. The computer-implemented method of claim 31, wherein the at least two of the plurality of serially-connected signal buffering devices that are the same type of device comprise re-driver devices.

34. The computer-implemented method of claim 31, wherein the at least two of the plurality of serially-connected signal buffering devices that are the same type of device comprise re-timer devices.

35. The computer-implemented method of claim 31, wherein the at least two of the plurality of serially-connected signal buffering devices that are the same type of device comprise re-timer and re-driver devices.

36. The computer-implemented method of claim 31, wherein the link comprises an Ethernet link.

37. The computer-implemented method of claim 36, further comprising employing Ethernet Auto-Negotiation (AN) next pages to convey device address information between at least one of the endpoint devices and each of the plurality of serially-connected signal buffering devices.

38. The computer-implemented method of claim 31, wherein each of the plurality of serially-connected signal buffering devices comprises one of N intermediate device in the serial chain of devices, the method further comprising:
at each of the N intermediate devices;
if the device is first intermediate device in the serial chain of devices,
receiving a base address from the first endpoint device; and
incrementing the base address by a predetermined amount to produce an incremented device address;
otherwise, if the intermediate device is not the first intermediate device in the serial chain of devices,
receiving a previous device address from a previous device in the serial chain of devices; and
incrementing the previous device address by a predetermined amount to produce an incremented device address;
storing the incremented device address on the intermediate device, the stored incremented device address comprising that intermediate device's unique device address; and
if the intermediate device is not the Nth intermediate device,
forwarding its incremented device address to be received as a previous device address by a next intermediate device in the serial chain of devices.

39. The computer-implemented method of claim 38, further comprising:
for each intermediate device in the serial chain of devices,
communicating the unique device address for the intermediate device to the first endpoint.

40. The computer-implemented method of claim 39, further comprising:
at each intermediate device in the serial chain of devices,
echoing its unique device address to its previous intermediate device;
for each intermediate devices in the serial chain of devices prior to the intermediate device echoing its unique device address,
forwarding the unique device address it receives to a previous device in the serial chain of devices.

41. An apparatus, comprising:
a network port, including a transmitter and a receiver; and
circuitry and logic that is configured, when the apparatus is implemented as a first endpoint device in a communication link between the apparatus and a second endpoint device, the communication link including a plurality of serially-connected signal buffering devices comprising intermediate devices in a serial chain of devices including the apparatus and the second endpoint device, to:
discover each of the plurality of intermediate devices; and
for each of the plurality of intermediate devices, at least one of configure and identify a unique device address for that intermediate device.

42. The apparatus of claim 41, wherein the circuitry and logic is further configured, when implemented as the first endpoint device, to:
transmit a message to a first intermediate device in the serial chain of devices including a base address; and
receive a device address from the first intermediate device that is generated as a function of the base address.

43. The apparatus of claim 41, wherein the apparatus further comprises non-volatile memory (NVM), and wherein the circuitry and logic is further configured, when implemented as the first endpoint device, to:
receive a respective device address from each of the plurality of intermediate devices; and
store the respective device addresses in the NVM.

44. The apparatus of claim 41, wherein the apparatus is an Ethernet apparatus, and the transmitter and receiver are configured to respectively transmit and receive Ethernet signals having a signaling rate of at least 25 Gigabits per second.

45. The apparatus of claim 44, wherein the circuitry and logic includes Ethernet Auto-Negotiation (AN) logic, and wherein discovery of each of the plurality of intermediate devices is facilitated by transmitting and receiving AN Next Pages.

46. The apparatus of claim 41, wherein the apparatus comprises a network interface controller (NIC).

47. An apparatus comprising a signal buffering device, including:
a first port having a first transmitter and a first receiver coupled to a first plurality of buffers;
a second port having a second transmitter and a second receiver coupled to a second plurality of buffers; and
circuitry and logic that is configured, when that apparatus is implemented as an intermediate device in a communication link including a plurality of serially-connected signal buffering devices, each comprising an intermediate device in a serial chain of devices, to:
receive an address at the first receiver from a previous device in the serial chain of devices;
increment the address to create an incremented address;
store the incremented address on the apparatus to be used as a unique device address in the serial chain of devices; and
transmit the incremented address from the second transmitter to a next device in the serial chain of devices.

48. The apparatus of claim 47, wherein the circuitry and logic is further configured, when the apparatus is implemented as an intermediate device in the serial chain of devices, to transmit the incremented address from the first transmitter to the previous device in the serial chain of devices.

49. The apparatus of claim 47, wherein the circuitry and logic is further configured, when the apparatus is implemented as an intermediate device in the serial chain of devices, to:
receive, at the second receiver, a message from the next device in the serial chain including a device address; and
forward the message from the first transmitter to the previous device in the serial chain.

50. The apparatus of claim 47, wherein the apparatus comprises a re-timing device and further comprises re-timing circuitry coupled to at least one buffer in each of the first and second plurality of buffers.

51. The apparatus of claim 47, wherein the apparatus comprises a re-driver device and further comprises re-driver circuitry coupled to at least one buffer in each of the first and second plurality of buffers.

52. The apparatus of claim 47, wherein the apparatus comprises a re-timing and re-driving device, further comprising:
re-timing circuitry coupled to at least one buffer in each of the first and second plurality of buffers; and
re-driver circuitry coupled to at least one buffer in each of the first and second plurality of buffers.

53. The apparatus of claim 47, wherein each of the first and second ports comprise Ethernet ports that are configured to transmit and receive Ethernet signals having a signaling rate of at least 25 Gigabits per second.

54. The apparatus of claim 53, wherein each of the first and second ports includes circuitry and logic comprising Ethernet Auto-Negotiation (AN) logic, and wherein the apparatus is configured to transmit and receive AN Next Pages.

55. A system comprising:
first and second endpoint devices, each endpoint device including,
a network port including a transmitter and a receiver;
a plurality of serially-connected signal buffering devices, each signal buffering device including,
a first port having a first transmitter and a first receiver coupled to a first plurality of buffers; and
a second port having a second transmitter and a second receiver coupled to a second plurality of buffers,
wherein the first endpoint device is connected to a first signal buffering device among the plurality of signal buffering devices, and an Nth signal buffering device among the plurality of signal buffering devices is connected to the second endpoint device to form a communication link comprising a serial chain of devices including N signal buffering devices, and
wherein the first and second endpoint devices and the plurality of signal buffering devices are configured to exchange messages to enable discovery of each of the signal buffering devices by at least one of the first and second endpoint devices and to configure each of the plurality of signal buffering devices with a unique device address in the serial chain of devices.

56. The system of claim 55, wherein each of the first and second endpoint devices and the plurality of signal buffering devices are Ethernet devices.

57. The system of claim 55, wherein each of the plurality of signal buffering devices is implemented as an intermediate device in a serial chain of devices forming a communication link coupling the first and second endpoints in communication, wherein each of the signal buffering devices is configured to:
receive an address at its first receiver from a previous device in the serial chain of devices;
increment the address to create an incremented address;
store the incremented address to be used as its unique device address in the serial chain of devices; and
transmit the incremented address from its second transmitter to a next device in the serial chain of devices.

58. The system of claim 57, wherein the first endpoint device is configured to send a base address to the first signal buffering device, the base address comprising the address received at the first receiver of the first signal buffering device.

59. The system of claim 55, wherein each of the plurality of signal buffering devices is configured to communicate its unique device address to the first endpoint device.

60. The system of claim 59, wherein, wherein each of the first and second endpoint devices and the plurality of signal buffering devices are Ethernet devices, wherein the first and second endpoints are configured to exchange Auto-Negotiation (AN) Pages in connection with setting up an Ethernet link that traverses the serial chain of devices, and wherein, each signal buffering device is configured to:
receive a first AN Page by from a previous device in the serial chain of devices;
add its device address to the first AN Page;
forward the first AN Page with its device address to a next device in the serial chain of devices;
receive a second AN Page from the next device in the serial chain of devices;
add its device address to the second AN Page; and
and forward the second AN Page including its device address to the previous device in the serial chain of devices.
